(19) United States
(12) Patent Application Publication
(10) Pub. No.: US 2013/0253706 A1
(43) Pub. Date: Sep. 26, 2013

(54) SAFETY SIGNAL PROCESSING SYSTEM

(71) Applicant: FANUC CORPORATION, Yamanashi (JP)

(72) Inventors: Kouji HADA, Yamanashi (JP); Yoshito MIYAZAKI, Yamanashi (JP)

(73) Assignee: FANUC CORPORATION, Yamanashi (JP)

(21) Appl. No.: 13/781,242

(22) Filed: Feb. 28, 2013

(30) Foreign Application Priority Data
Mar. 26, 2012 (JP) 2012-070021

(51) Int. Cl. G05B 19/18

(52) U.S. Cl. CPC G05B 19/18
USPC 700/275

(57) ABSTRACT

In a safety signal processing system, a DMA controller is embedded inside a communication controller of a numerical controller, and dedicated memories 1 and 2 are provided in a CPU 1 and a CPU 2. Every time of performing communication with an I/O unit 1 or an I/O unit 2, the communication controller performs DMA transfer to the dedicated memory 1 or 2 of the corresponding CPU 1 or 2, and the transfer destination can be changed by a configuration register inside the communication controller. A transfer route uses a dedicated bus, and thus, transfer can be carried out without arbitration or queuing.

### BACKGROUND OF THE INVENTION

1. Field of the Invention

The present invention relates to a safety signal processing system for performing exchange of safety signals between a numerical controller and an IO unit.

2. Description of the Related Art

As shown in FIG. 5, a numerical controller (CNC) 80 for controlling a machine tool includes a CPU 81, a communication controller 82 having a memory 83, a servo controller 84, a communication controller 85 and a bus 86 for connecting these components. Also, an I/O unit 87 includes a communication controller 88 for inputting/outputting signals, and performs exchange of signals with the numerical controller 80 and other I/O units (not shown).

A configuration of connecting a plurality of external signal input/output units (I/O units 87) is employed between the numerical controller (CNC) 80 and a machine tool to input/output DI/DO data signals (input signal/output signal). Normally, transfer of DI/DO data signals is performed between the numerical controller 80 and the I/O unit 87 via a communication channel 89. These DI/DO data signals include safety signals necessary for avoiding danger or the like, such as an emergency stop signal or a door switch.

Now, as safety standards for electrical and electronic safety-related systems and machine control systems, there are IEC 61508, ISO 13849-1 and the like, and the safety signals mentioned above are desirably processed and transferred according to these standards.

With respect to signal processing, normally, when compliant with SIL3 (Safety Integrity Level 3) of IEC 61508, separate execution of a safety function by duplicate central processing units (processors (CPUs)) is required. This is because, to obtain a sufficiently long mean time to dangerous failure (MTTd) and a sufficiently low probability of failure per hour (PFH), a redundancy in the system is required (see US 2008/0155318 A1).

Furthermore, the I/O unit 87 having a driver 90 and a receiver 91 for the input/output signals is also required duplication thereof in the same way. To easily connect the duplicate I/O units and the duplicate CPUs, they may be connected using duplicate communication channels.

FIG. 6 shows a conventional duplicate safety signal processing system.

The numerical controller 80 includes two CPUs 81a and 81b, a communication controller 82a having a memory 83a, and a communication controller 82b having a memory 83b. The I/O unit 87a includes a communication controller 88a, a driver 90a and a receiver 91a. The I/O unit 87b includes a communication controller 88b, a driver 90b and a receiver 91b.

The communication controller 88a of the I/O unit 87a is connected to the communication controller 82a of the numerical controller 80 via a communication channel 89a. Also, the communication controller 88b of the I/O unit 87b is connected to the communication controller 82b of the numerical controller 80 via a communication channel 89b.

However, generally, duplication of a communication channel connecting I/O units and CPUs entails increase in the cost, and it is difficult to balance safety and cost. If possible, it is better that safety is maintained with a communication channel that is not duplicate. As a communication method that is compliant with safety standards based on a non-duplicate communication channel, there is known PROFIsafe by PROFIBUS Nutzerorganisation e.V., for example.

In general, in communication in an FA system environment, errors such as repetition, loss, insertion and incorrect sequence may occur, but with PROFIsafe, assignment of count values (“sign of life”), expected time value (“Watch-dog”), a codename between a sender and a receiver (“F-Address”), data integrity check (CRC=Cyclic Redundancy Check) and the like are included with respect to communication data, which are checked by the receiver of the transfer to secure the safety regarding occurrence of errors. Duplication of the communication channel is unnecessary according to this method (PROFIsafe-Safety Technology for PROFIBUS and PROFINET System Description Version 20 July 2007 Order Number 4.342).

Here, a system in which a numerical controller and an I/O unit are connected will be considered. If a transfer method by a non-duplicate communication channel of PROFIsafe described above or the like is applied to between the I/O unit and the CPU 81a and between the I/O unit and the CPU 81b, a safety signal processing system in which the CPU and an input/output signal are duplicate can be realized using non-duplicate communication.

However, if, as with PROFIsafe, duplicate CPUs and duplicate I/O units are connected by a non-duplicate communication channel and safety signals are processed independently by the duplicate CPUs, two CPUs will, as a result, access the non-duplicate communication channel. In the case of both the CPUs performing access at a completely independent timing, a conflict between both the CPUs may occur due to the CPUs accessing one memory at the same time, resulting in the occurrence of a loss due to a processing time for arbitrating the conflict.

Particularly, in recent years, the scale of a machine tool has been becoming increasingly larger and the number of safety signals is therefore also on the increase, and the number of conflicts to be arbitrated increases as the number of safety signals to be processed increases. In this manner, connection by a non-duplicate communication channel is more advantageous in comparison to duplicate communication channels from the standpoint of cost and the ease of connection and configuration, but has a problem that occurrence of lost time resulting from the arbitration at the time of occurrence of conflicts as described above will lead to reduction in the specifications such as communication and servo control and reduction in the processing capacity.

### SUMMARY OF THE INVENTION

Accordingly, the present invention, taking the problem of the conventional technique described above into consideration, has its object to provide a safety signal processing system that allows no occurrence of lost time resulting from arbitration for conflicts on buses while suppressing the cost by a non-duplicate communication channel.

In a first embodiment of the safety signal processing system according to the present invention, a numerical controller that controls a machine and a plurality of input/output units are connected via a communication channel, and the numerical controller includes a plurality of arithmetic processing units, storage units having storage regions assigned respectively to the plurality of arithmetic processing units, and a communication control unit having a function of transferring data to the storage regions assigned respectively to the plurality of arithmetic processing units, and also, of acquiring data from the storage regions. On the other hand, the plurality of input/output units each include a communication controller. Furthermore, the communication control unit of the numerical controller transfers input/output data to be transferred, while performing sorting, according to an address set in advance, of the input/output data among the plurality of input/output units and the storage regions assigned respectively to the plurality of arithmetic processing units of the numerical controller. On the other hand, the plurality of arithmetic processing units access respectively the storage regions assigned to the plurality of arithmetic processing units.

In a second embodiment of the safety signal processing system according to the present invention, a numerical controller that controls a machine and one input/output unit are connected via a communication channel, and the numerical controller includes a plurality of arithmetic processing units, storage units having storage regions assigned respectively to the plurality of arithmetic processing units, and a communication control unit having a function of transferring data to the storage regions assigned respectively to the plurality of arithmetic processing units, and also, of acquiring data from the storage regions. On the other hand, the input/output unit includes a plurality of communication controllers. Furthermore, the communication control unit of the numerical controller transfers input/output data to be transferred, while performing sorting, according to an address set in advance, of the input/output data among the plurality of communication controllers of the input/output unit and the storage regions assigned respectively to the plurality of arithmetic processing units of the numerical controller. On the other hand, the plurality of arithmetic processing units access respectively the storage regions assigned to the plurality of arithmetic processing units.

According to the present invention, a safety signal processing system can be provided that allows no occurrence of lost time resulting from arbitration for conflicts on buses while suppressing the cost by a non-duplicate communication channel.

### BRIEF DESCRIPTION OF THE DRAWINGS

The object mentioned above, other objects and characteristics of the present invention will be made clear from the description of the embodiments below with reference to appended drawings. Among the drawings:

FIG. 1 is a diagram for describing a first embodiment of a safety signal processing system according to the present invention;

FIG. 2 is a diagram for describing DMA transfer by the safety signal processing system shown in FIG. 1;

FIG. 3 is a diagram for describing a data structure of the safety signal processing system shown in FIG. 1;

FIG. 4 is a diagram for describing a second embodiment of the safety signal processing system according to the present invention;

FIG. 5 is a diagram for describing a conventional signal processing system; and

FIG. 6 is a diagram for describing a conventional duplicate safety signal processing system.

### DETAILED DESCRIPTION OF THE PREFERRED EMBODIMENTS

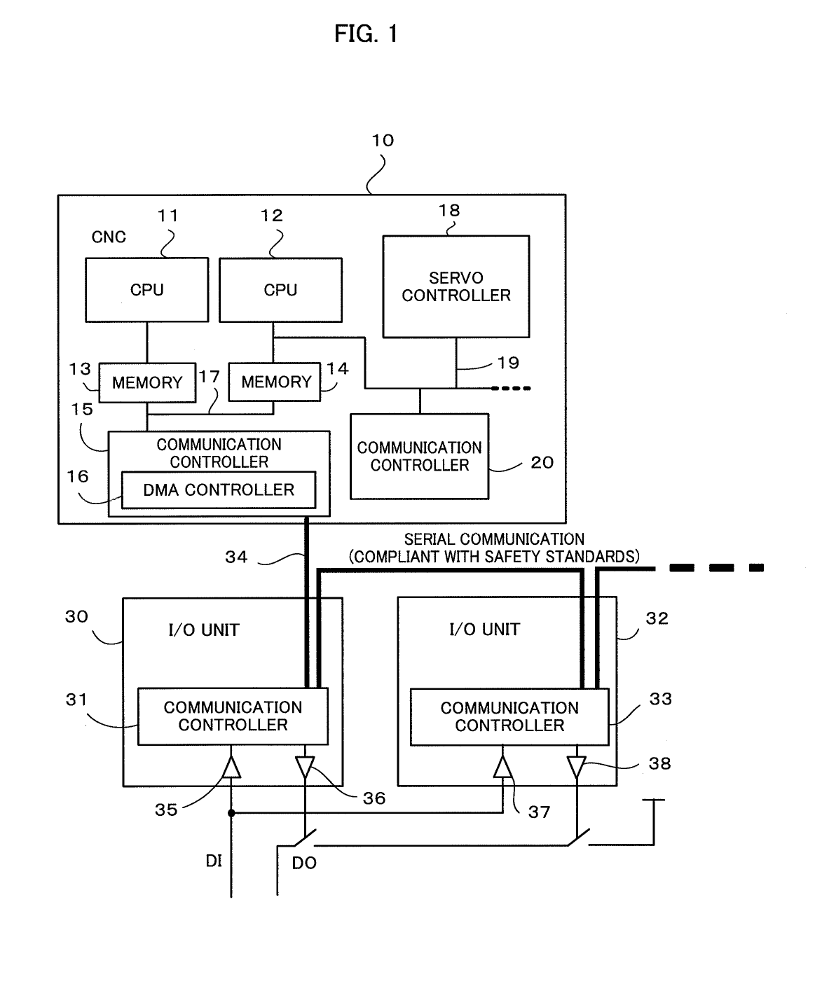

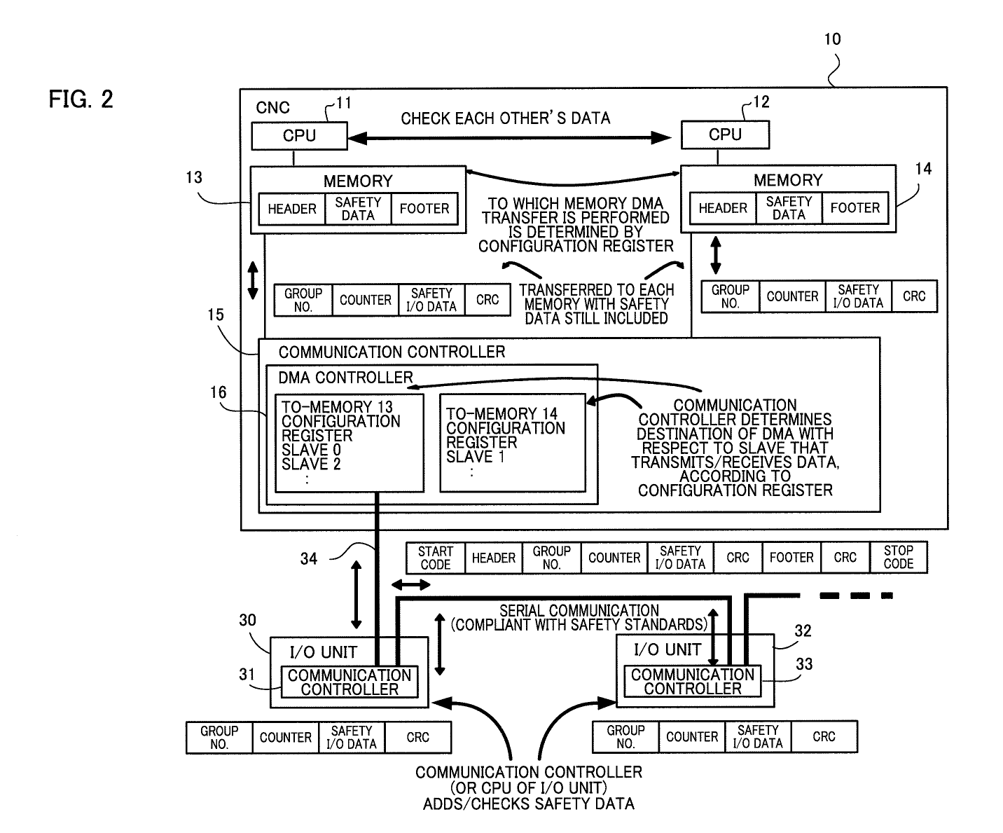

A first embodiment of a safety signal processing system according to the present invention will be described using FIGS. 1 and 2.

As shown in FIG. 1, in the safety signal processing system, a DMA controller 16 is embedded inside a communication controller 15 of a numerical controller (CNC) 10, and dedicated memories 13 and 14 are provided in respective CPUs 11 and 12. The communication controller 15 of the numerical controller (CNC) 10 performs DMA (Direct Memory Access) transfer to each of the dedicated memory 13 of the CPU 11 and the dedicated memory 14 of the CPU 12 every time communication is performed with each I/O unit 30 or 32. The transfer destination can be changed by setting the same to a configuration register or the like inside the DMA controller 16 provided in the communication controller 15 at the time of turning on the power, and in the case of not using the safety signal processing system, it is possible to have only one memory as the destination. This transfer route uses a dedicated bus 17 which is not connected to the other CPU, a servo controller 18 or the like, and thus, transfer can be carried out without arbitration or queuing. On the other hand, the CPU can update I/O data by accessing a memory dedicated to itself at a convenient time while performing servo control or the like, and thus, unnecessary queuing or the like does not occur.

The numerical controller (CNC) 10 for controlling a machine tool is connected with the I/O unit 30 and the I/O unit 32 via a communication channel 34. The numerical controller (CNC) 10 and the I/O unit 30 are connected via the communication channel 34 by serial communication. Also, the I/O unit 30 and the I/O unit 32 are connected via the communication channel 34 by serial communication. A communication scheme complying with safety standards is used for the serial communication.

The numerical controller (CNC) 10 includes the two arithmetic processing devices (the CPU 11 and the CPU 12), the memory 13, the memory 14 and the communication controller 15. The DMA controller 16 is embedded in the communication controller 15, the communication controller 15 and the memories 13 and 14 are connected by a dedicated bus 17, and data can be preferentially exchanged any time. Furthermore, the CPU 11 is related to the memory 13 and the CPU 12 is related to the memory 14, and the CPU 11 is not allowed to access the memory 14 and the CPU 12 is not allowed to access the memory 13. The DMA controller 16 is capable of accessing only the regions of the memories 13 and 14 that are set in advance in a configuration register (not shown).

Additionally, although not shown in FIG. 1, the CPU 11 and the CPU 12 are connected to a control circuit or the like other than the communication controller 15. The I/O unit 30 includes a communication controller 31, and the I/O unit 32 includes a communication controller 33.

The numerical controller (CNC) 10 performs transmission/reception of DI/DO data signals (input signal/output signal) with the I/O unit 30 via the communication controller 15, the communication channel 34 and the communication controller 31. The I/O unit 30 performs transmission/reception of DI/DO data signals (input signal/output signal) with the numerical controller (CNC) 10 and the I/O unit 32 by serial communication using the communication controller 31. To input/output a DI/DO data signal to outside (a machine tool), the I/O unit 30 includes a receiver 35 and a driver 36, and the I/O unit 32 includes a receiver 37 and a driver 38.

The communication controller 15 of the numerical controller 10 acts as a master, and the communication controllers 31 and 33 of the I/O units 30 and 32 act as slaves, and they perform one-to-one communication by a master-slave method. The communication controller 15 of the numerical controller 10 can be automatically started at a regular interval or a given timing by a start signal from outside. When the communication controller 15 is started, DO data is acquired by the DMA controller 16 from predetermined regions of the memories 13 and 14. The acquired DO data is transferred to the side of the I/O units 30 and 32 by communication. Also, DI data acquired on the side of the I/O units 30 and 32 is updated and stored in predetermined regions of the memories 13 and 14 by the DMA controller 16.

Also, the DMA controller 16 sorts and transfers the DI/DO data to the memory 13 or the memory 14. Which piece of DI data is to be transferred to which of the two memories (the memory 13, the memory 14) is determined by a value (the value of an address) set in advance in a configuration register inside the DMA controller 16. On the other hand, the two CPUs (the CPU 11, the CPU 12) each access the memories assigned to them for accessing at their own timings and independently perform processing. In this safety signal processing system, arbitration occurring for the access to each memory is performed only for the conflicting state between the CPU 11 and the DMA controller 16 and the conflicting state between the CPU 12 and the DMA controller 16, and no arbitration occurs because of a direct conflict between the CPU 11 and the CPU 12.

Next, DMA transfer in the safety signal processing system of the present invention will be described using FIG. 2. Here, an explanation will be given on the DO data, but the same is true of the DI data.

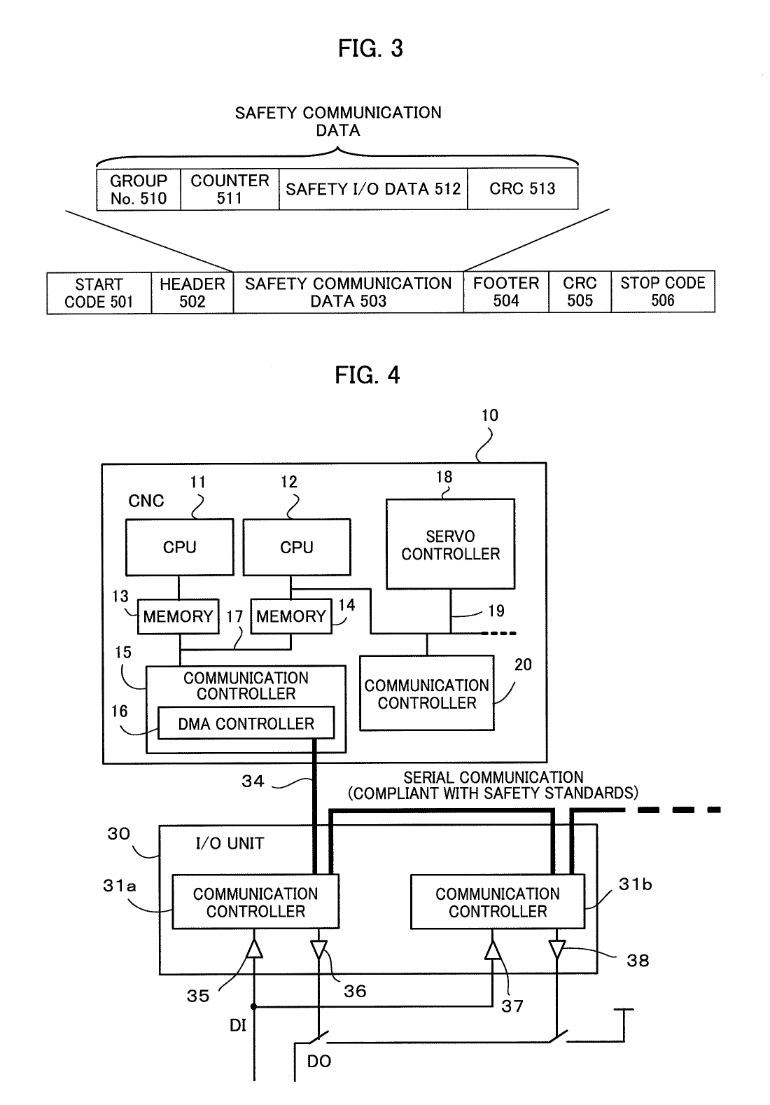

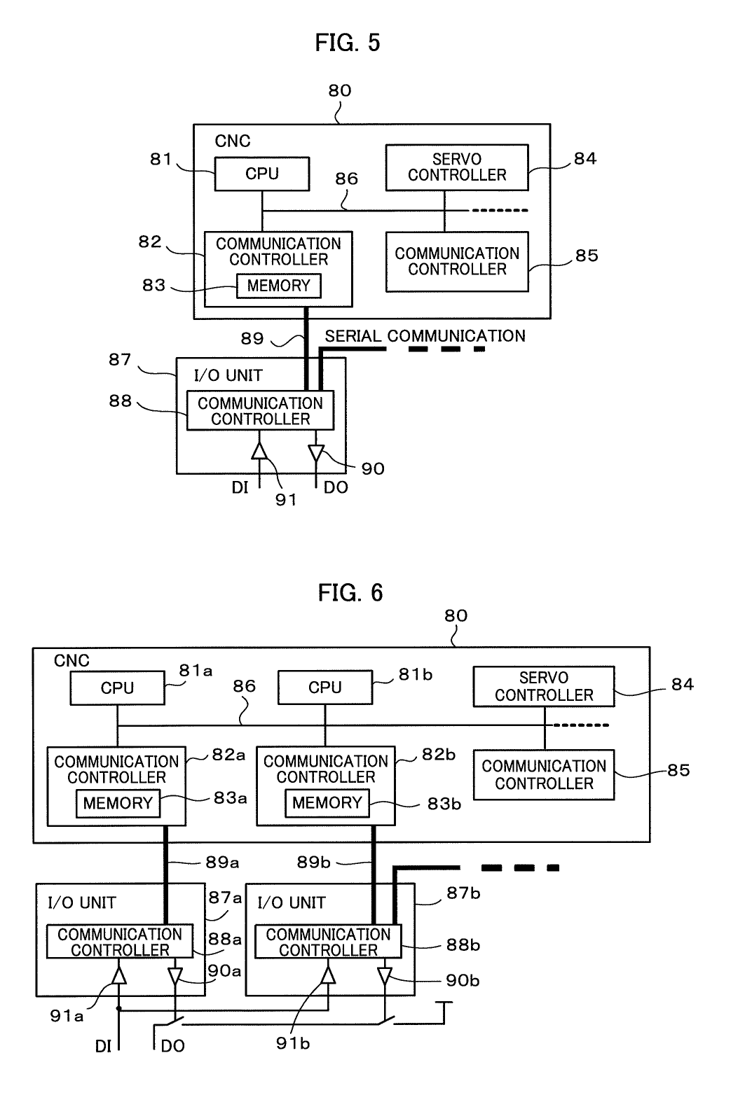

The DO data to be output from the I/O unit 30 is generated by the CPU 11. Also, the CPU 12 generates, for the I/O unit 32, the same DO data as the DO data generated by the CPU 11. At the time of the CPU 11 and the CPU 12 generating the DO data, a group number 510, a counter 511 and a CRC 513 as shown in FIG. 3 are added. Since the CPU 11 and the CPU 12 each also perform control other than communication, they transfer the generated DO data to the memories 13 and 14 using a spare time from the main control.

The communication controller 15 of the numerical controller 10 operates asynchronously with the CPU 11 and the CPU 12. When it is the timing of communication with the I/O unit 30, the communication controller 15 acquires the data for the I/O unit 30 from the memory 13 using DMA transfer by the DMA controller 16. At this time, the group number 510, the counter 511 and the CRC 513 added by the CPU 11 are acquired as they are, and safety I/O data 512 to which the group number 510, the counter 511 and the CRC 513 have been added, that is, the safety communication data 503, is treated as usual DO data.

The communication controller 15 of the numerical controller 10 transmits the safety communication data 503 to which a usual start code 501, a usual header 502, a usual footer 504, a usual CRC 505 and a usual stop code 506 have been added, to the communication controller 31 of the I/O unit 30.

The communication controller 31 of the I/O unit 30 which has received the safety communication data 503 to which the start code 501, the header 502, the footer 504, the CRC 505 and the stop code 506 have been added performs a check on the usual start code 501, the usual header 502, the usual footer 504, the usual CRC 505 and the usual stop code 506, and then, further performs a check on the group number 510, the counter 511 and the CRC 513, and if there is no abnormality, outputs the DO data to a machine tool (not shown).

Also in the case where the I/O unit 30 acquires the DI data from a machine tool (not shown) and transmits the data to the master (the numerical controller 10), the communication controller 31 of the I/O unit 30 adds the group number 510, the counter 511 and the CRC 513 for a safety signal to the DI data which has been acquired, then further adds the start code 501, the header 502, the footer 504, the CRC 505 and the stop code 506 that are used in usual communication, and transmits the data to the master (the communication controller 15 of the numerical controller 10).

The communication controller 31 which has received the data from the communication controller 33 of the I/O unit 32 performs a check on the start code 501, the header 502, the footer 504, the CRC 505 and the stop code 506 that are used in usual communication, and if there is no abnormality, transfers the safety communication data 503 to the memory 13 of the numerical controller 10.

The CPU 11 uses a spare time from control and acquires the safety communication data 503 of the I/O unit 30 from the memory 13. The group number 510, the counter 511 and the CRC 513 added to the acquired safety communication data 503 are checked, and if there is no abnormality, the safety communication data 503 is treated as the DI data of the I/O unit 30.

The DO data to be transferred to the I/O unit 32 is generated and transmitted by the CPU 12 and the DI data of the I/O unit 32 is acquired by the CPU 12 by the same method as that described above. Regarding the DO data, since the same data is output from the I/O units 30 and 32, a circuit is made by which output to a machine tool is performed only when the values coincide. This allows highly reliable data to be output. Furthermore, input from the machine tool is input to both the I/O units 30 and 32. Since this DI data is transmitted to the CPUs 11 and 12, the CPUs 11 and 12 mutually check whether the data they have acquired coincide and treat the data as valid data only in the case of coincidence, and the numerical controller (CNC) can thereby acquire highly reliable data.

Each of the communication controllers 15, 31 and 33 and the CPUs 11 and 12 has means for interrupting communication or a function of displaying an alarm when an error is found at the time of the check.

A second embodiment of the safety signal processing system according to the present invention will be described using FIG. 4.

In this embodiment, two communication controllers (a first communication controller 31a and a second communication controller 31b) are mounted in one I/O unit 30. That is, in this embodiment, two I/O units 30 and 32 of the first embodiment (FIG. 1) are replaced by one I/O unit 30, and the communication controllers 31 and 33 mounted on the I/O units 30 and 32, respectively, are mounted on the one I/O unit 30.

1. A safety signal processing system in which a numerical controller that controls a machine and a plurality of input/output units are connected via a communication channel,
wherein the numerical controller includes
a plurality of arithmetic processing units,
storage units having storage regions assigned respectively to the plurality of arithmetic processing units, and
a communication control unit having a function of transferring data to the storage regions assigned respectively to the plurality of arithmetic processing units, and also, of acquiring data from the storage regions,
wherein the plurality of input/output units each include a communication controller,
wherein the communication control unit of the numerical controller transfers input/output data to be transferred, while performing sorting, according to an address set in advance, of the input/output data among the plurality of input/output units and the storage regions assigned respectively to the plurality of arithmetic processing units of the numerical controller, and
wherein the plurality of arithmetic processing units access respectively the storage regions assigned to the plurality of arithmetic processing units.

2. A safety signal processing system in which a numerical controller that controls a machine and one input/output unit are connected via a communication channel,
wherein the numerical controller includes
a plurality of arithmetic processing units,
storage units having storage regions assigned respectively to the plurality of arithmetic processing units, and
a communication control unit having a function of transferring data to the storage regions assigned respectively to the plurality of arithmetic processing units, and also, of acquiring data from the storage regions,
wherein the input/output unit includes a plurality of communication controllers,
wherein the communication control unit of the numerical controller transfers input/output data to be transferred, while performing sorting, according to an address set in advance, of the input/output data among the plurality of communication controllers of the input/output unit and the storage regions assigned respectively to the plurality of arithmetic processing units of the numerical controller, and
wherein the plurality of arithmetic processing units access respectively the storage regions assigned to the plurality of arithmetic processing units.
